(19) United States
(12) Patent Application Publication
(10) Pub. No.: US 2025/0363579 A1
(43) Pub. Date: Nov. 27, 2025

(54) AUTOMATED EVALUATATION OF USER SUBJECT MATTER MASTERY STATUS BASED ON ONE OR MORE ACADEMIC STANDARDS

(71) Applicant: 2hr Learning, Inc., Austin, TX (US)

(72) Inventors: Bogdan Tenea, Bucharest (RO); Simon Said, Malta (MA)

(73) Assignee: 2hr Learning, Inc., Austin, TX (US)

(21) Appl. No.: 19/218,320

(22) Filed: May 25, 2025

Related U.S. Application Data
(60) Provisional application No. 63/652,138, filed on May 27, 2024.

(51) Int. Cl. G06Q 50/20; G06F 16/22

(52) U.S. Cl. CPC G06Q 50/205; G06F 16/2282

(57) ABSTRACT

A system and method to evaluate the mastery status of a user and recommend learning resources is disclosed. Receiving plurality of input parameters via a mastery evaluation and learning resource recommendation system. The hierarchical table generation module generates a hierarchical table based on the plurality of input parameters. The hierarchical table represents parent-child relationships linking the standards. Furthermore, the mastery status detection module receives a user performance data from the user performance database. The mastery status detection module first maps the learning resources to the corresponding standard within the hierarchical table and then utilizes algorithms to classify the learning resources into essential and non-essential learning resources and calculate the mastery status of the user. The learning resource recommendation module further recommends the learning resources to the user to attain mastery for the specific standard.

### CROSS-REFERENCE TO RELATED APPLICATION

This application claims the benefit under 35 U.S.C. § 119 (e) and 37 C.F.R. § 1.78 of U.S. Provisional Application No. 63/652,138, filed May 27, 2024, which is incorporated by reference in its entirety.

### FIELD OF THE INVENTION

The present invention relates in general to the field of electronics and, more specifically, to evaluate mastery status of a user and recommending learning resources aligned with the academic standards.

### BACKGROUND OF THE INVENTION

Traditional educational tracking systems have been notably limited in their approach to monitoring student progress. The traditional educational tracking track achievements exclusively within the boundaries of individual courses or academic years without establishing connections between related content areas. Such compartmentalization creates fragmented student records that fail to capture the holistic nature of learning, where knowledge and skills frequently build upon and intersect with one another across different subjects and grade levels.

Conventional educational systems typically employ inflexible hierarchical frameworks that cannot easily adapt to the varying structures established by different standards organizations such as common core and college board. This one-size-fits-all approach fails to represent the nuanced relationships between standards, clusters, domains, and courses, particularly in digital learning environments where interconnected representation is crucial for effective content mapping and mastery assessment.

### SUMMARY

A method for dynamically evaluating mastery status of a user based on one or more academic standards, includes executing code using one or more processors of a computer system to cause the computer system to perform operations that includes receiving a plurality of input parameters from a database, wherein the plurality of input parameters includes one or more academic standards related to one or more curriculum, wherein each curriculum includes one or more courses such that each course includes one or more units, and each unit includes one or more topics and associated standards. The method also includes generating a hierarchical table based on the plurality of input parameters, wherein the hierarchical table shows relationship of the one or more academic standards within the curriculum and relates the one or more academic standards to one or more curriculums. The method also includes receiving user performance data, including data related to one or more learning resources accessed by the user and associated mastery level of the user on the accessed learning resources. The method includes utilizing an algorithm to compare the user performance data to the hierarchical table for calculating a mastery status against the one or more academic standards. The method also includes updating the mastery status of the user corresponding to the one or more academic standards.

A method for dynamically recommending learning resources to a user based on mastery on one or more academic standards includes executing code using one or more processors of a computer system to cause the computer system to perform operations that include receiving a plurality of input parameters from a database, including one or more academic standards related to one or more curriculum, wherein each curriculum includes one or more courses such that each course includes one or more units, and each unit includes one or more topics and associated standards. The method also includes generating a hierarchical table based on the plurality of input parameters, wherein the hierarchical table shows the relationship of the one or more academic standards within the curriculum and relates the one or more academic standards to one or more curriculums. The method also includes receiving one or more learning resources from a database. The method includes utilizing an algorithm to map the one or more learning resources to the hierarchical table for mapping the learning resources to the one or more academic standards. The method also includes receiving user performance data on the one or more learning resources indicating mastery level of the user on the one or more learning resources. The method also includes recommending at least one learning resource to the user based on the mastery level of the user on the one or more academic standards

A system for dynamically evaluating mastery status of a user based on one or more academic standards includes one or more processors of a computer system and a memory, coupled to the one or more processors, storing code that when executed by the computer system causes the computer system to perform operations. The operation includes receiving a plurality of input parameters from a database, via a mastery evaluation and learning resource recommendation system, wherein the plurality of input parameters includes one or more academic standards related to one or more curriculum, wherein each curriculum includes one or more courses such that each course includes one or more units, and each unit includes one or more topics and associated standards. The system also includes generating a hierarchical table, via a hierarchical table generation module, integrated within the mastery evaluation and learning resource recommendation system, based on the plurality of input parameters, wherein the hierarchical table shows the relationship of the one or more academic standards within the curriculum and relates the one or more academic standards to one or more curriculums. The system also includes receiving user performance data from a user performance database via a mastery status detection module integrated within the mastery evaluation and learning resource recommendation system, including data related to one or more learning resources accessed by the user and the associated mastery level of the user on the accessed learning resources. The system includes utilizing an algorithm via the mastery status detection module to compare the user performance data to the hierarchical table for calculating a mastery status against the one or more academic standards. The system also includes updating the mastery status of the user corresponding to the one or more academic standards.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary adaptive learning and evaluating system to evaluate mastery status of a user based on one or more academic standards and recommend learning resources based on the mastery status.

FIG. 2 depicts an exemplary adaptive learning and evaluating process to evaluate the mastery status of the user based on one or more academic standards and recommend learning resources based on the mastery status.

FIG. 3 depicts an exemplary flow diagram showing the hierarchy between the plurality of input parameters for generating hierarchical table using the adaptive learning and evaluating system of FIG. 1.

FIG. 4 depicts an exemplary flow diagram representing the process of the generation of the hierarchical table using the adaptive learning and evaluating system of FIG. 1.

FIG. 5 depicts an exemplary diagram showing data structure including multiple objects used to store and organize the data for hierarchical table generated using the adaptive learning and evaluating system of FIG. 1.

FIG. 6 depicts an exemplary diagram showing data structure, including multiple objects used to store and organize the data for mastery status evaluation of the adaptive learning mastery evaluating system of FIG. 1.

FIG. 7 depicts an exemplary diagram showing data structure, including multiple objects used to store and organize the data for mastery status evaluation across multiple courses of the adaptive learning and evaluating system of FIG. 1.

FIG. 8 depicts an exemplary network environment in which the system of FIG. 1 and the process of FIG. 2 may be practiced.

FIG. 9 depicts an exemplary computer system.

### DETAILED DESCRIPTION

A system and method to evaluate the mastery status of a user and recommend learning resources aligned to one or more curriculum standards is disclosed. adaptive learning and evaluating system. The adaptive learning and evaluating system utilizes different modules to evaluate the mastery status of the user and recommend learning resources. A mastery evaluation and learning resource recommendation system receives plurality of input parameters, including one or more courses, such that each course or more units such that each unit includes one or more topics and associated one or more standards. The plurality of input parameters represents the academic standards. The mastery evaluation and learning resource recommendation system includes three components: a hierarchical table generation module, a mastery status detection module, and a learning resource recommendation module. The hierarchical table generation module receives plurality of input parameters and utilizes algorithms to generate a hierarchical table aligned to one or more curriculums. Typically, the hierarchical table is in the tree form, where the course represents the parent, and unit, topic, and standards represent the children. The hierarchical table shows relationships of how multiple child standards are linked to the parent standards. The hierarchical table is furthermore used in the mastery status evaluation and learning resource recommendation.

The mastery status detection module receives user performance data from a user performance database. The user performance database includes the learning resources the user has accessed and the corresponding mastery level for the learning resources. The mastery status detection module first maps the learning resources belonging to a particular standard to the standards in the hierarchical table. Furthermore, the mastery status detection module utilizes an algorithm to determine the essential learning resources and non-essential learning resources. The mastery status detection module then determines the mastery status of the user in the essential learning resources and updates the mastery status of the user.

The mastery status detection module also detects the mastery status of the user across multiple courses for the standards common in the multiple courses to prevent redundant reading of learning materials that have been mastered by the user.

Once the mastery status is updated, the learning resource recommendation system recommends the learning resources that the user has not yet mastered. The mastery status and the recommended learning resources are presented to the user on an user interface.

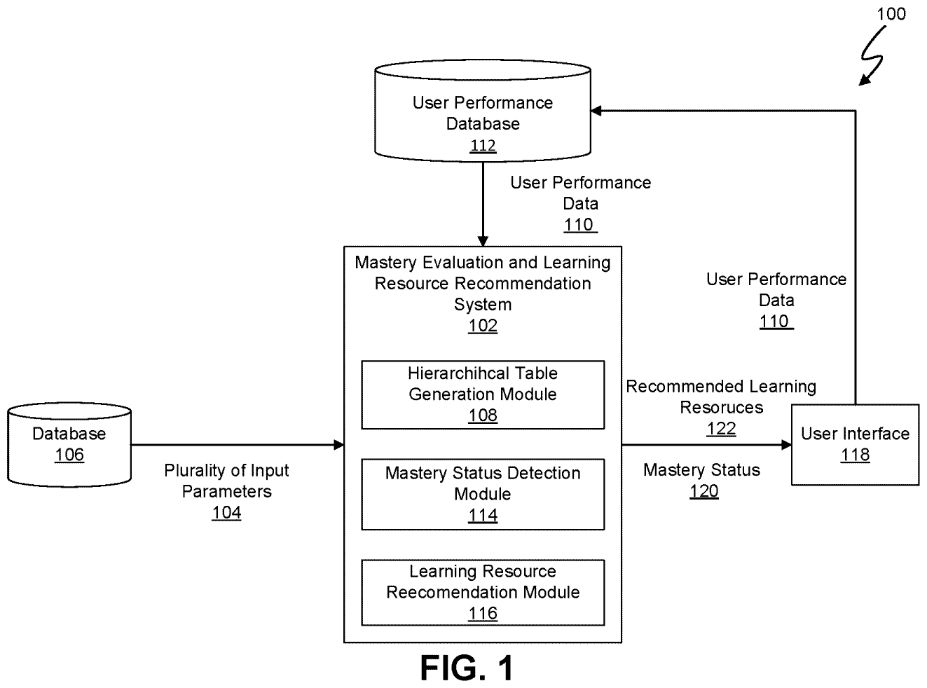

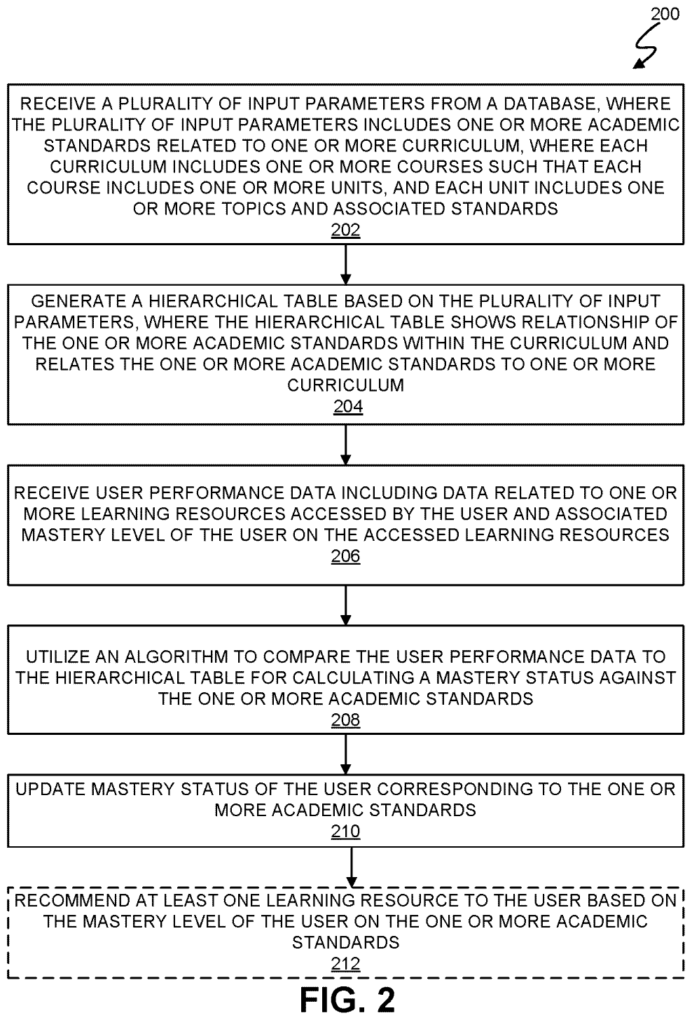

FIG. 1 depicts an exemplary adaptive learning mastery evaluating system 100 to evaluate mastery status of a user based on one or more academic standards and recommend learning resources. FIG. 2 depicts an exemplary adaptive learning and evaluating system process 200 to evaluate the mastery status of the user based on the one or more academic standards and recommend learning resources.

In operation 202, a mastery evaluation and learning resource recommendation system 102 receives a plurality of input parameters 104. The plurality of input parameters 104 are received from a database 106.

The plurality of input parameters 104 includes one or more academic standards related to one or more curriculums such that each curriculum includes one or more courses. Each course consists of one or more units such that each unit consists of one or more topics and associated standards.

The curriculum is a detailed and organized plan for teaching and learning. Curriculum is a standard-based sequence of planned experiences for a user. The user can either be a student, instructor, teacher, or administrator. The plurality of input parameters 104 are aligned with different educational bodies, including Common Core Standards and College Board Standards.

Common Core Standards are a set of academic guidelines that are designed to ensure that the users receive a high-quality education. The Common Core standards focus on English Language Arts (ELA) and mathematics, aiming to build critical thinking, problem-solving, and analytical skills. The Common Core standards outline specific learning objectives for each grade level, from kindergarten through 12th grade. The Common Core standards are organized into courses, domains, clusters, and standards.

The College Board standards primarily include academic frameworks and assessments designed for college-level work. The College Board standards are organized into courses, units, topics, and standards. The College Board standards define the knowledge and skills that a user must demonstrate in different courses like mathematics, science, history, and English.

The plurality of input parameters 104 are stored within database 106. The database 106 is an organized collection of data, which in this case is plurality of input parameters 104 that can be accessed by the mastery evaluation and learning resource recommendation system 102. The database 106 acts as a blueprint and defines the layout for the data to be stored.

The database 106 within the adaptive learning mastery evaluating system 100 is a relational database. The relational database stores the plurality of input parameters 104 in the form of structured tables, where each table consists of rows and columns. Each table represents a specific type of data. In at least one of the embodiments, the relational tables can be made using a relational database system like MySQL or PostgreSQL. The relational database consists of tables for courses, units/domains, topics/clusters, and standards. The relational database ensures the relationship between the tables using primary keys and foreign keys. The primary key is a unique identifier for each record in a table. The primary key ensures that no two rows have the same value in that column. The foreign key is a field in one table that refers to the primary key in another table. The foreign key creates a relationship between the two tables, allowing data to be connected and queried together.

The primary keys include the data stored within database 106, represented using unique IDs. Each course, unit/domain, topic/cluster, and standard have a unique ID represented as standard_id, cluster_id, domain_id, course_id which define the primary keys for each table. For the course table, the unique identifier ‘course_id’ includes the unique ID (primary key) of the course. For instance, within the course table, the unique ID for the science course can be C01, and the unique ID for the math course can be C02. The unique identifier helps to distinguish individual courses from each other. Similarly, for the unit/domain table, the unique identifier domain_id includes the unique ID (primary key) representing the unit/domain. For instance, the primary key within the unit/domain table can be U101 for the unit States of Matter, along with the course ID to which it relates, i.e. C01 (foreign key). The foreign key within the unit/domain table creates a relationship on how the unit/domain is linked to the course. The units are a section within the course that focuses on a specific theme or concept. For instance, the course “AP Biology’ includes different units such as “Chemistry of Life”, “Cell Structure and Functions”, “Heredity”, “Ecology”, and various others.

The unique identifier cluster_id includes the unique ID for one or more topics/cluster corresponding to the course and unit. Moreover, the cluster_id includes relevant details for one or more topics. For instance, the unit ‘Cell Structure and Functions” includes different topics such as “prokaryotic cells vs. eukaryotic cells” and various others. The unique identifier standard_id includes a unique ID for each one or more standards belonging to the course, unit, and topics. The standards define the learning goals of the user at the end of the course.

The presence of primary keys and foreign keys helps establish a relationship between the various educational standards in each curriculum. For instance, the data within the database 106 is stored in the following tabular format:
Course ID: CSE101, Course name: Computer Science
Unit ID: U101, Unit name: Introduction to CS, Course ID: CSE101

The mastery evaluation and learning resource recommendation system 102 receives the plurality of input parameters 104 from the database 106. The mastery evaluation and learning resource recommendation system 102 includes three components: a hierarchical table generation module 108, a mastery status detection module 114, and a learning resource recommendation module 116. The mastery evaluation and learning resource recommendation system 102 orchestrates the entire workflow and implements the code to evaluate the mastery status 120 and further recommends learning resources 122.

In operation 204, generating a hierarchical table based on the plurality of input parameters 104. The hierarchical table shows the relationship of the one or more academic standards within the curriculum and to the one or more curriculums.

The hierarchical table generation module 108 receives the plurality of input parameters 104 using a Structured Query Language (SQL). SQL is a standard programming language used to manage and manipulate data in relational databases 106. SQL language helps store, retrieve, update, and delete data using simple, readable commands like SELECT, INSERT, UPDATE, and DELETE. SQL is widely used in applications, websites, and data systems to interact with databases 106 efficiently and is essential for managing structured data stored in tables with rows and columns.

The hierarchical table generation module 108 utilizes tables containing the plurality of input parameters 104 from the database 106 and implements the use of tree traversal algorithms to generate the hierarchical table. The hierarchical table is represented as a tree-like model where the plurality of input parameters 104 within one or more academic standards has parent-child relationships. The hierarchical table also includes information on how the common standards within one or more curriculums are related. The hierarchical table can have multiple levels where children are nested under parent rows. The hierarchical table includes only one root, which is the starting point and does not have the parent ID.

The algorithm analyzes each row within the relational table to find the parent using the foreign keys. The parent table will be the one holding the main or referenced data, usually with a unique identifier (primary key). The hierarchical table generation module 108 then utilizes algorithms and adds children to the main parent data. The child table holds related or dependent data and includes a foreign key that refers to the primary key of the parent. In this way multiple children are added to one parent, and a hierarchical relationship is established between courses, units/domains, topics/clusters, and standards.

The hierarchical relationship provides a view on how the course is bifurcated into multiple units, how each unit is bifurcated into topics, and how each topic is further bifurcated into standards.

Below represents an exemplary code utilized by the hierarchical table generation module 108 to generate hierarchical table:

```
  Define a class to represent a standard within the hierarchy
  class Standard:
    def _{——}init_{——}(self, id, name, description, parent_id=None):
      self.id = id
      self.name = name
      self.description = description
      self.parent_id = parent_id
      self.children = [ ]
    # Function to add a child standard to the current standard
    def add_child(self, child_standard):
      self.children.append(child_standard)
  # Function to build the hierarchical structure from a list of
standards
  def build_hierarchy(standards_list):
    standards_dict = { }
    root_standards = [ ]
    # Create standard objects and store them in a dictionary
for quick access
    for standard_info in standards_list:
      standard = Standard(standard_info[‘id’],
standard_info[‘name’], standard_info[‘description’],
standard_info[‘parent_id’])
      standards_dict[standard.id] = standard
    # Assign children to their respective parent standards
    for standard_id, standard in standards_dict.items( ):
      if standard.parent_id:
        parent_standard =
standards_dict[standard.parent_id]
        parent_standard.add_child(standard)
      else:
        root_standards.append(standard)
    return root_standards
```

The code class: standard includes information on the details required for the course, unit/domain, topic/cluster and standard. The hierarchical table generation module 108 implements the code def_init_ and utilizes the information from the relational tables to create a new standard object. The new standard object includes self, id, name, description, parent_id for each course, unit/domain, topic/cluster, and standard.

Each standard object has parent_id and possibly a method add_child( ) that adds a child to it. The standard objects are further stored in a standards_dict. The standards_dict is a dictionary used to store data in key-value pairs. The keys are standard_ids (usually integers or strings that uniquely identify each standard).

The hierarchical table generation module 108 further utilizes the code Assign children to their respective parent standards to add children to the parent standards and generate hierarchical table. The code parent_standard=standards_dict[standard.parent_id] checks if the standard within the standard objects has a parent ID. If it has some value, then it is added to the hierarchical table. The code else executes if standard.parent_id is none or otherwise false. This means the standard does not have a parent, and therefore, it's a root standard indicating the first level in the hierarchy. When a standard has no parent, then the standard gets added to the root standard. The root standards are the top-level entries within the hierarchical table and the child standards are connected to the parent standards

Below represents an example of hierarchical table generated using the hierarchical table generation module 108:

```
  standards_list = [
  # {‘id’: ‘1’, ‘name’: ‘Math’, ‘description’: ‘Mathematics',
‘parent_id’: None},
  # {‘id’: ‘1.1’, ‘name’: ‘Algebra’, ‘description’: ‘Study of
mathematical symbols', ‘parent_id’: ‘1’},
  # # ... more standards
  # ]
  # hierarchy = build_hierarchy(standards_list)
```

The hierarchical table generation module 108 first utilizes the relational table for plurality of input parameters 104 to create a standard object containing the detail for each course, unit/domain, topic/cluster, and standard.

The id: 1 is the unique identifier for the first standard in the list representing the course Math and has parent_id: None indicating that it is the root standard or the parent standard. The next standard within the list has id 1.1 for Algebra and has parent ID: “1”. The parent ID: 1 acts as foreign key indicating that the standard 1.1 is linked to standard 1 and belongs under this category. In this way, more child standards having the same parent ID are added to this root standard, and a hierarchy is built, establishing a relationship between the various standards.

Furthermore, the hierarchical table generation module 108 also provides relationships of the standards within the curriculums with the same standards in the other curriculums. The hierarchical table is also updated using SQL by creating, updating and deleting records in the database.

In operation 206, the mastery status detection module 114 receives user performance data 110. The user performance data 110 includes data related to one or more learning resources accessed by the user and the associated mastery level of the user on the accessed learning resources.

Once the hierarchical table is generated, the mastery status detection module 114 receives user performance data 110. The user accesses one or more learning resources to attain mastery of the one or more academic standards within the curriculum. The user accesses the learning resources via an user interface 118. The user interface 118 is a way in which the user interacts with the device. The user interface 118 encompasses all the visual and interactive elements, like buttons, icons, and menus, that enable users to give instructions to a system and receive information in return.

The user can access multiple learning platforms, including Khan Academy, IXL, CommonLit, Google Docs, etc., and utilize the learning resources from each platform to master a particular standard. The learning resources are tools, materials, or content that support learning by explaining concepts. The learning resources on these platforms can either be a video for teaching math, a textbook for a specific subject, or, a game app for practice. The learning platforms also provide practice tests to determine the mastery level after understanding the learning resource. In at least one of the embodiments, the practice test can be multiple-choice questions (MCQ), true/false, fill-in-the-blanks, and more.

The mastery level defines the degree of proficiency and understanding the user has achieved while performing the one or more practice tests on the one or more learning platforms. In at least one embodiment, the mastery level can be calculated as a percentage, levels of proficiency, or scoring assessments.

The user performance database 112 stores the user performance data 110 including the mastery level and the accessed learning resources received via the user interface 118. The user performance database 112 stores the one or more learning resources the user has accessed and mastery level in the form of a table. The table includes the resource_id, student_id, mastery_status. The resource_id includes the list of one or more resources accessed by the user along with their unique ID. The mastery_status indicates the mastery level of the user for the learning resource accessed by the user on different learning platforms.

The mastery status detection module 114 utilizes the SQL language to receive the user performance data 110 from the user performance database 112.

In operation 208, the mastery status detection module 114 utilizes an algorithm to compare the user performance data 110 to the hierarchical table for calculating a mastery status 120 against the one or more academic standards.

The mastery status detection module 114 maps the one or more learning resources accessed by the user to the corresponding one or more academic standards within the hierarchical table and utilizes an algorithm to determine essential learning resources and non-essential learning resources. The algorithm maps the elements within the resource ID to that of the standard_id within the hierarchical table to find the learning resources directly relevant and important required to master the standard. Data mapping using algorithms involves the automated process of connecting data fields from a resource_id, to their corresponding fields in a standard_id. This is essential in scenarios like data migration, integration, or transformation tasks. The process typically begins by analyzing the schemas (structures) of both the resource_id and standard_id. Algorithms are then applied to identify the best matches between resource_id and standard_id based on name similarity, data type, or metadata to identify essential and non-essential learning resources. For instance, the learning resources can be a quiz related to algebra, a video game app, and the standard in the corresponding hierarchical table belongs to understanding and manipulating algebraic expressions and solving equations. The algorithm will further classify the quiz related to algebra as an essential learning resource and the game app as a non-essential learning resource.

The essential learning resources are the core materials that are required to meet learning objectives. The essential learning resources will be linked to the one or more academic standards defined within the hierarchical table. The non-essential learning resources need not be studied by the user and can be excluded.

Once the mastery status detection module 114 classifies the learning resources as essential learning resources and non-essential learning resources, the mastery status detection module 114 calculates the mastery status 120 of the user against one or more academic standards. The mastery status detection module 114 receives the mastery level of the user across various learning resources and analyzes, using algorithms, the mastery level across essential learning resources. The mastery level typically includes the number of correct and incorrect answers, the sequence of those answers (e.g., correct answers in a row), the time taken to respond, and sometimes the difficulty of the questions for the essential learning resources. If the user has attained mastery across all the essential learning resources, the mastery status 120 is updated. If the user has not properly answered all the essential learning resources, the mastery status 120 will be updated. Using this data, the algorithm applies a model ranging from simple rules to advanced statistical methods to estimate the student's current knowledge state. For example, a basic algorithm may consider a student to have mastered a skill after getting 4 out of the last 5 questions correct, indicating consistent understanding.

Below represents an exemplary code to determine the mastery status 120 of the user across multiple applications:

```
  def evaluate_mastery(standard_id, learning_resources):
    essential_resources =
filter_essential_resources(learning_resources, standard_id)
    mastered_resources = [res for res in essential_resources if
res[‘mastered’]]
    # Check if all essential resources are mastered
    if len(essential_resources) == len(mastered_resources):
      return True
    else:
      return False
  # Helper function to filter essential resources for a standard
  def filter_essential_resources(learning_resources,
standard_id):
    return [res for res in learning_resources if
res[‘standard_id’] == standard_id and res[‘type’] == ‘essential’]
```

The code def defines a function evaluate mastery to determine the mastery of the user based on the mastery level and interaction of the user with one or more learning resources corresponding to the standards within the hierarchical table. The code essential_resources=filter_essential_resources(learning_resources, standard_id) utilizes algorithms to filter the essential learning resources from one or more learning resources accessed by the user that map to the corresponding standard id.

All the essential resources are put together in the essential resources object. Based on the list of essential resources mapped to the corresponding standards, a new list called mastered_resources is generated. The essential_resources includes the list of educational resources like videos, books, assignments, etc.

The code res for res in essential_resources iterates over every item in essential_resources. The code if res[‘mastered’] is an optional filter condition. It checks if each item (res) satisfies some condition, and only those items that satisfy the condition will be included in the new list, mastered_resources.

The code return True only if all the essential resources within the standard are mastered and return False only if all the essential resources are not mastered.

Furthermore, the mastery status detection module 114 determines the mastery status 120 of the common standards within multiple courses. The mastery status detection module 114 utilizes the hierarchical table to link the common standards in the multiple courses. Furthermore the master status detection module 114 evaluates the user performance data 110 across the common standards in multiple courses and updates the mastery status 120 accordingly.

Below represents an exemplary code to evaluate the mastery status 120 of common shared standards across multiple courses:

```
  # Define a function to track mastery across multiple courses
  def track_mastery_across_courses(student_id, standard_id,
courses):
    mastery_records = get_mastery_records(student_id,
standard_id)
    courses_with_standard = [course for course in courses if
standard_id in course[‘standards']]
    # Check if the student has demonstrated mastery in any of
the courses
    for course in courses_with_standard:
      if any(record[‘course_id’] == course[‘id’] and
record[‘mastered’] for record in mastery_records):
        return True
    return False
  # Helper function to retrieve mastery records for a student and
standard
  def get_mastery_records(student_id, standard_id):
    # This function would interact with the database to
retrieve records
    # Placeholder for actual database interaction
    return [ ]
  # Example usage:
  # student_id = ‘student123’
  # standard_id = ‘std1’
  # courses = [
  # {‘id’: ‘course1’, ‘name’: ‘Algebra I’, ‘standards':
[‘std1’, ‘std2’]},
  # {‘id’: ‘course2’, ‘name’: ‘Geometry’, ‘standards':
[‘std3’, ‘std1’]},
  # # ... more courses
  # ]
  # mastery_across_courses =
track_mastery_across_courses(student_id, standard_id, courses)
```

The mastery status detection module 114 retrieves mastery records of the user to check the mastery status 120 of the user across multiple courses. The mastery status detection module 114 utilizes the get_mastery_records(student_id, standard_id) to identify if the user has mastered the corresponding standard. The code return True if the user has mastered the standard in the specific course and returns false if the user has not mastered. This indicates that user has mastered across the standard present in the one or more courses.

For instance, the user has taken AP Calculus AB and AP Calculus BC which share several standards. The mastery detection module 114 updates the mastery status 120 for that standard in AP Calculus AB and AP Calculus. The tracking the mastery status 120 of common standards across multiple courses requires a minimum score to reflect mastery status across the academic standards.

In operation 210, the mastery status detection module 114 updates the mastery status 120 of the user corresponding to the one or more academic standards.

Once the mastery status 120 is calculated, the mastery status detection module 114 updates the mastery status 120 of the user for the corresponding standard. The mastery status 120 of the user defines the learning of the user for all the essential learning resources. The mastery status 120 can be represented as beginner or mastered. The mastery status 120 “beginner,” represents that the user has a little understanding of the concept for that standard and requires more practice to attain mastery for that standard. The mastery status 120 “mastered” indicates that the user has mastered all the essential learning resources within the particular standard.

Once the mastery status 120 of the user has been updated, the learning resource recommendation module 116 recommends learning resources 122 based on the mastery status 120 of the user. If the user has a beginner mastery status 120, the learning resource recommendation module 116 recommends learning resources 122 from the hierarchical table that are essential to master the standard. The user's transcript also reflects mastery status 120 of the common standards across multiple courses, allowing the user to attain mastery in one or more subjects sharing common standards, thereby preventing redundant testing.

The mastery status 120 is displayed to the user on the user interface 118 presenting a unified view of the user's mastery level on different learning platforms.

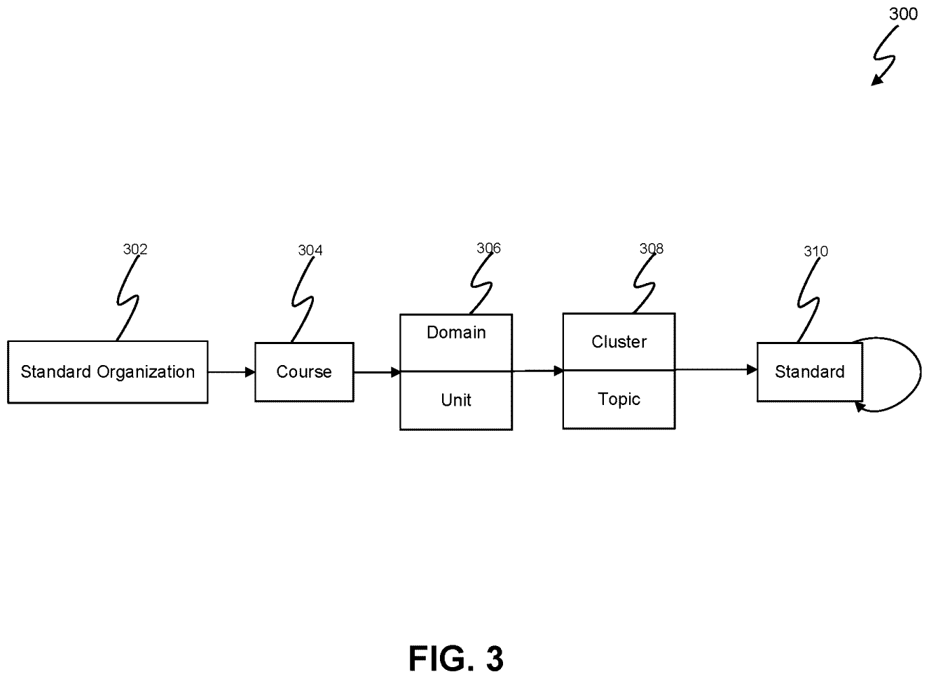

FIG. 3 depicts an exemplary flow diagram 300 showing the hierarchy between the plurality of input parameters 104 for generating hierarchical table using the adaptive learning mastery evaluating system 100 of FIG. 1.

The flow diagram 300 begins with standard organization 302 that includes the hierarchy for one or more curriculums standards. The standard organization 302 includes guidelines defining what the user should learn at each level in the curriculums. The guidelines within the standard organization influence the design of course 304, including content, structure, learning objectives, and assessments. Standard Organization 302 includes content aligned with Common Core Standards and College Board standards.

The course 304 is built to meet the standard requirements of standard organization 302. The course 304 includes the subject that must be taught the entire year to cover broad learning goals. For instance, the course 304 includes a unique ID for each course. The course 304 can be “Math,” “Science”, “History”, and various others.

The course 304 further includes a domain/unit 306 that focuses on the major section of the course 304. The domain/unit 306 breaks the course into manageable parts. For instance, the course 304 Mathematics includes different domains/units 306 such as “Algebra 1”, “Inequalities” and various others.

The domain/unit 306 further includes cluster/topic 308. The cluster/topic 308 represents a specific concept or skill within the domain/unit 306. For instance, the domain/unit 306 such as “Algebra 1” includes different cluster/topic 308 such as “Order of Operations”, “Solving Linear Equations” and various others.

Each cluster/topic 308 further includes standards 310 that define the learning goal of the user at the end of the course.

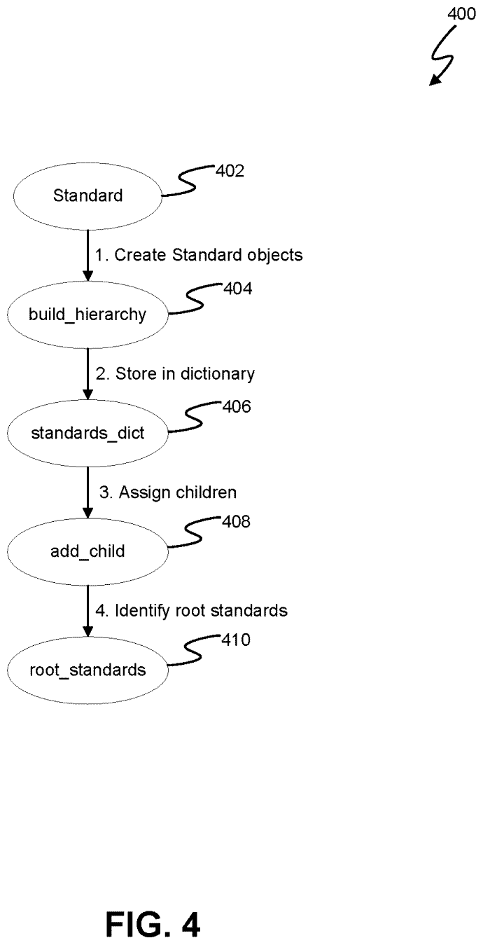

FIG. 4 depicts an exemplary flow diagram 400 representing the process of the generation of the hierarchical table using the adaptive learning mastery evaluating system 100 of FIG. 1.

The process begins by creating standard objects using a standard 402. A class is defined to represent the standard 402. The class includes the following details for each course 304, domain/unit 306, cluster/topic 308, standards 310 such as id, name, description, parent ID, self-children. This information within the standard 402 is utilized to create standard objects to build_hierarchy 404.

The standard object holds the following data, such as standard ID, name description, parent ID. The data is further stored in a standard_dict 406. The standard_dict 406 includes foreign keys in the form of standard ID and values are standard objects.

Once the standard-dict 406 contains all the relevant information, the hierarchical table generation module 108 assigns the children to the parent standard. A add_child 408 object assigns the child to the parent. The parent standard is looked up in the standard_dict 406 using the parent ID. The add_child 408 object further includes checking if the current standard has parent. If the current standard has the parent, the child is added to the add_child 408. If the current standard has no parent, then it is added to root_standard 410.

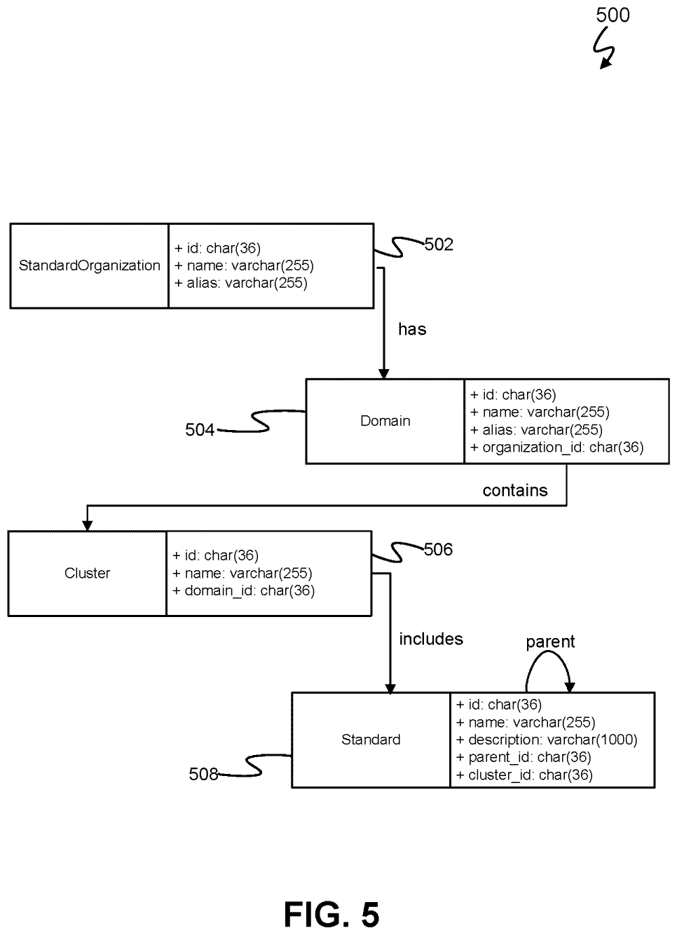

FIG. 5 depicts an exemplary diagram showing data structure 500 including multiple objects used to store and organize the data for hierarchical tale generated using adaptive learning mastery evaluating system 100 of FIG. 1.

A data structure includes standard organization object 502 object that represents the courses of one or more curriculums. The standard organization 502 object includes an ID, name in the form +id: char (36), +name: varchar (255). The + represents a variable or field name (in this case, id). Within the standard organization object 502 the char and varchar are used to store character strings. Char stores string of fixed length, and varchar stores string of variable length. The Char can be used for consistent data such as ID and varchar is used for data with more variable length such as name. The 36 represents the that the id is string of 36 characters.

The object standard organization 502 further has a domain 504 object which defines the units within the course. The domain 504 object includes a ID, name, organization_ID in the form of +id: char (36), +name: varchar (255), +organization_ID: char (36). Each unit has a unique ID, name, and the link to the organization object 502 object.

The domain 504 object further includes a cluster 506 object. The cluster object includes information on topics related to the course, having data in the form of +id: char (36), +name: varchar (255), +domain_id (36).

The cluster 506 object further includes a standard object 508. The standard object includes +id: char (36), +name: varchar (255), +description: varchar (1000), +parent_id: char (36), +cluster_id: char (36).

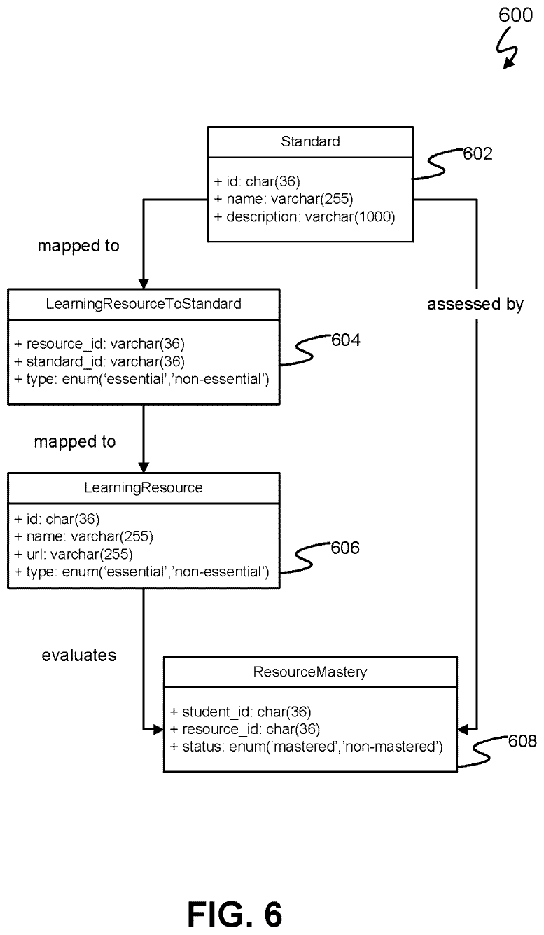

FIG. 6 depicts an exemplary diagram showing data structure 600 including multiple objects used to store and organize the data for mastery status 120 evaluation of the adaptive learning mastery evaluating system 100 of FIG. 1.

A data structure 600 includes a standard object 602. The standard object 602 includes +id: char (36), +name: varchar (255), +description: varchar (1000). The data within the standard object 602 is mapped to a LearningResourceToStandard object 604. The LearningResourceToStandard object 604 includes the data in the form of +resource_id: varchar (36), +standard_id: varchar (36), + type: enum(‘essential, ‘non-essential’).

The LearningResource object 606 now includes tid: char (36), +name: varchar (255), +url: varchar (255), + type: enum(‘essential, ‘non essential’). The URL contains the link to visit essential learning resource.

The mastery status 120 is calculated based on the mastery level of the user on the essential learning resources accessed by the user. A ResourceMastery object 608 contains the following data: +student_id: char (36), +resource_id: char (36), +status: enum (‘mastered’, ‘non-mastered’)

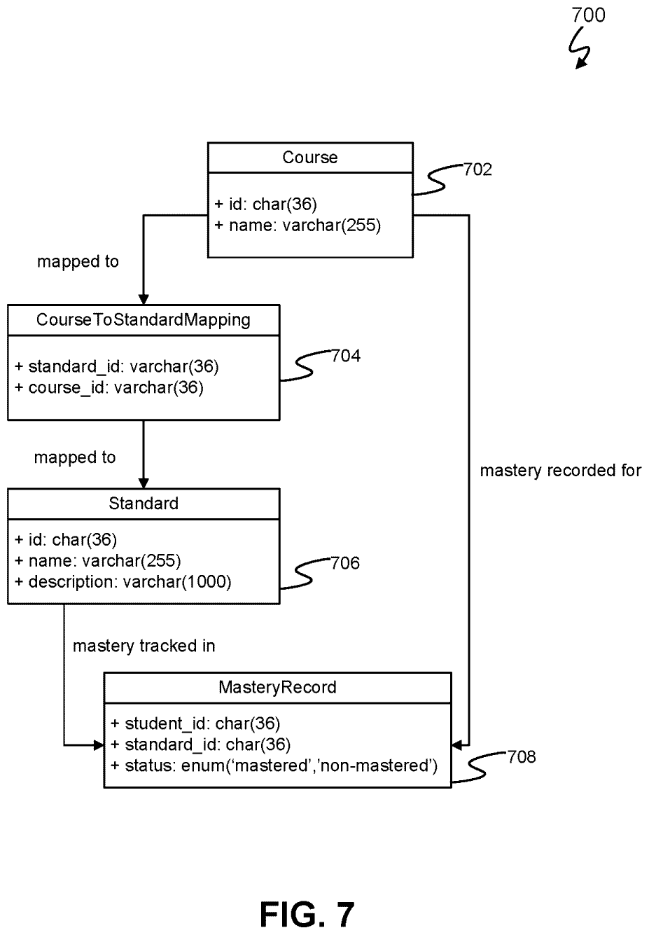

FIG. 7 depicts an exemplary diagram showing data structure 700 including multiple objects used to store and organize the data for mastery status 120 evaluation across multiple courses of the adaptive learning mastery evaluating system 100 of FIG. 1.

A data structure 700 includes a course object 702. The course object 702 includes +id: char (36), +name: varchar (255), +. The data within the course object 702 is mapped to a CourseToStandardMapping object 704 to find how one standard belongs to multiple courses. The mapped data is stored within a Standard object 706 and the mastery record is stored in a MasteryRecord object 708 that records the mastery status 120 of the user across multiple courses for the same standard.

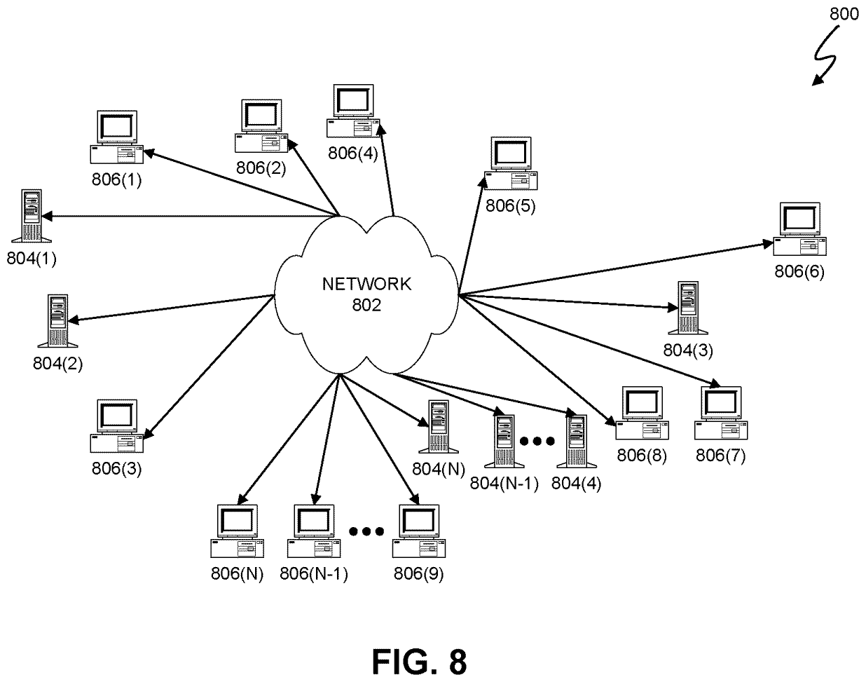

FIG. 8 is a block diagram illustrating a network environment in which adaptive learning mastery evaluating system 100 and adaptive learning and evaluating process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the adaptive learning mastery evaluating system 100 and adaptive learning and evaluating process 200. The type of computer system that can be specially programmed to implement and utilize the adaptive learning mastery evaluating system 100 and adaptive learning and evaluating process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the adaptive learning mastery evaluating system 100 and adaptive learning and evaluating process 200 can be implemented using code stored in a tangible, non-transient computer readable medium and executed by one or more processors. In at least one embodiment, the adaptive learning mastery evaluating system 100 and adaptive learning and evaluating process 200 can be implemented completely in hardware using, for example, logic circuits and other circuits, including field programmable gate arrays.

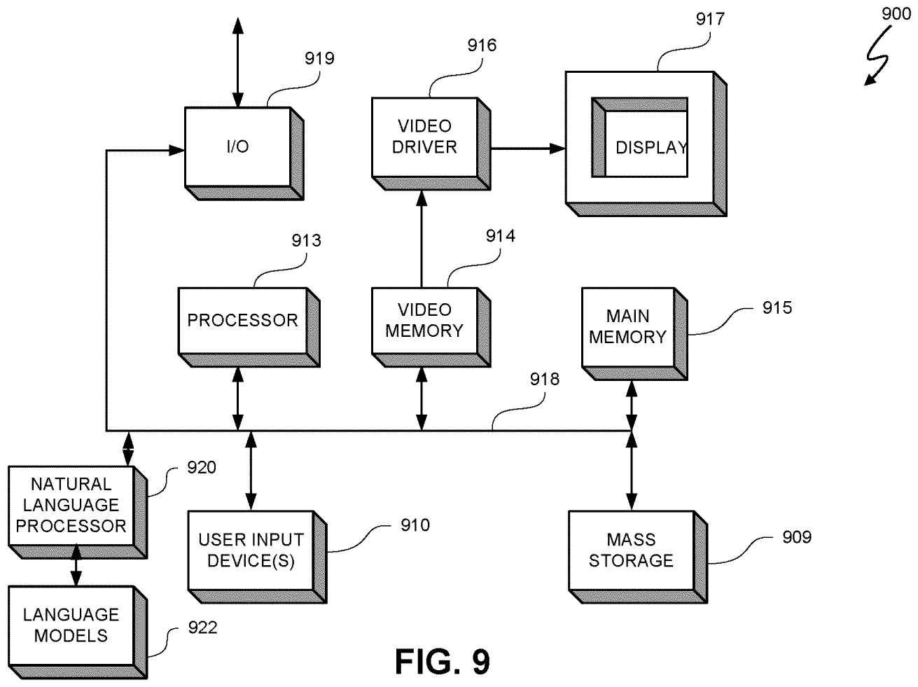

Embodiments of the adaptive learning mastery evaluating system 100 and adaptive learning and evaluating process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 1016 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The adaptive learning mastery evaluating system 100 and adaptive learning and evaluating process 200 may be implemented in any type of computer system or programming or processing environment. It is contemplated that the adaptive learning mastery evaluating system 100 and adaptive learning mastery evaluating process 200 might be run on a stand-alone computer system, such as the one described above. The adaptive learning mastery evaluating system 100 and adaptive learning and evaluating process 200 might also be run from a server computer systems system that can be accessed by a plurality of client computer systems interconnected over an intranet network. Finally, the adaptive learning mastery evaluating system 100 and adaptive learning and evaluating process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for dynamically evaluating mastery status of a user based on one or more academic standards, the method comprising:
executing code using one or more processors of a computer system to cause the computer system to perform operations comprising:
receiving a plurality of input parameters from a database, wherein the plurality of input parameters includes one or more academic standards related to one or more curriculum, wherein each curriculum includes one or more courses such that each course includes one or more units, and each unit includes one or more topics and associated standards;
generating a hierarchical table based on the plurality of input parameters, wherein the hierarchical table shows relationship of the one or more academic standards within the curriculum and relates the one or more academic standards to one or more curriculums;
receiving user performance data including data related to one or more learning resources accessed by the user and associated mastery level of the user on the accessed learning resources;
utilizing an algorithm to compare the user performance data to the hierarchical table for calculating a mastery status against the one or more academic standards;
updating the mastery status of the user corresponding to the one or more academic standards.

2. The method of claim 1, wherein the plurality of input parameters is aligned with the Common Core Standard and college board students.

3. The method of claim 1, wherein the hierarchical table includes one or more academic standards, clusters, and details relevant to each one or more academic standards.

4. The method of claim 1, wherein the hierarchical table is represented as a tree-like model wherein the one or more academic standards has parent-child relationship with the other one or more academic standards.

5. The method of claim 1, wherein the hierarchical table further includes updating the hierarchical table by creating, updating and deleting records in the database.

6. The method of claim 1, wherein the mastery level of the user indicates the mastery of the user for the accessed learning resources received via different learning platforms.

7. The method of claim 1, wherein the mastery status indicates the proficiency and understanding the user has while accessing the one or more learning resources.

8. A method for dynamically recommending learning resources to a user based on mastery on one or more academic standards, the method comprising:
executing code using one or more processors of a computer system to cause the computer system to perform operations comprising:
receiving a plurality of input parameters from a database, includes one or more academic standards related to one or more curriculum, wherein each curriculum includes one or more courses such that each course includes one or more units, and each unit includes one or more topics and associated standards;
generating a hierarchical table based on the plurality of input parameters, wherein the hierarchical table shows relationship of the one or more academic standards within the curriculum and relates the one or more academic standards to one or more curriculums;
receiving one or more learning resources from a database;
utilizing an algorithm to map the one or more learning resources to the hierarchical table for mapping the learning resources to the one or more academic standards;
receiving user performance data on the one or more learning resources indicating mastery level of the user on the one or more learning resources; and
recommending at least one learning resource to the user based on the mastery level of the user on the one or more academic standards.

9. The method of claim 8, wherein utilizing the algorithm further comprises:
mapping the learning resources corresponding to the standards within the hierarchical table,
utilizing algorithms to evaluate the learning resources accessed by the user as essential learning resources and non-essential learning resources.

10. The method of claim 8, wherein evaluating the mastery status of the user across multiple courses for the common standards further comprises:
utilizing the hierarchical table to link the common standards in multiple courses,
evaluating the user performance data across the common standards in multiple courses, and
updating the mastery status across multiple courses sharing common academic standards.

11. The method of claim 8, wherein tracking the mastery status of common standards across multiple courses requires a minimum score to reflect mastery status across the academic standards.

12. The method of claim 8, wherein the mastery status and recommended learning resources are further displayed to the user on a user interface.

13. A system for dynamically evaluating mastery status of a user based on one or more academic standards, the system comprising:
one or more processors of a computer system; and
a memory, coupled to the one or more processors, storing code that when executed by the computer system causes the computer system to perform operations comprising:
receiving a plurality of input parameters from a database, via a mastery evaluation and learning resource recommendation system, wherein the plurality of input parameters includes one or more academic standards related to one or more curriculum, wherein each curriculum includes one or more courses such that each course includes one or more units, and each unit includes one or more topics and associated standards;
generating a hierarchical table, via a hierarchical table generation module, integrated within the mastery evaluation and learning resource recommendation system, based on the plurality of input parameters, wherein the hierarchical table shows relationship of the one or more academic standards within the curriculum and relates the one or more academic standards to one or more curriculums;
receiving, a user performance data from a user performance database, via a mastery status detection module, integrated within the mastery evaluation and learning resource recommendation system, including data related to one or more learning resources accessed by the user and associated mastery level of the user on the accessed learning resources;
utilizing an algorithm via the mastery status detection module to compare the user performance data to the hierarchical table for calculating a mastery status against the one or more academic standards;
updating the mastery status of the user corresponding to the one or more academic standards.

14. The system of claim 13, wherein the academic standards are aligned with the Common Core standard and college board students.

15. The system of claim 13, wherein the hierarchical table includes one or more academic standards, clusters, and details relevant to each one or more academic standards.

16. The system of claim 13, wherein the hierarchical table generation module further includes updating the hierarchical table by creating, updating and deleting records in the database.

17. The system of claim 13, wherein the child standards reference the parent standards, allowing a scalable representation of educational standards.

18.

19. The system of claim 13, wherein the user performance data, including mastery level of the user and learning resources accessed by the user is received from different learning applications.
